(19) United States
(12) Patent Application Publication
(10) Pub. No.: US 2025/0077490 A1
(43) Pub. Date: Mar. 6, 2025

(54) DATA DELETION CONTROL DEVICE AND NON-TRANSITORY COMPUTER-READABLE STORAGE MEDIUM STORING PROGRAM

(71) Applicant: SEIKO EPSON CORPORATION, Tokyo (JP)

(72) Inventor: Yusuke YAMADA, SHIOJIRI-SHI (JP)

(21) Appl. No.: 18/816,705

(22) Filed: Aug. 27, 2024

(30) Foreign Application Priority Data
Aug. 30, 2023 (JP) 2023-139685

(51) Int. Cl. G06F 16/215

(52) U.S. Cl. CPC G06F 16/215

(57) ABSTRACT

A tablet device includes: an acquisition unit configured to acquire data from each of a plurality of source devices including a first source device and a second source device; a data storage unit configured to store the data acquired by the acquisition unit; and a deletion unit configured to execute deletion processing of deleting the data from the data storage unit in response to a preset deletion condition being satisfied when the data is acquired from the first source device, the deletion unit prohibiting execution of the deletion processing of the data when the data is acquired from the second source device.

The present application is based on, and claims priority from JP Application Serial Number 2023-139685,filed Aug. 30, 2023, the disclosure of which is hereby incorporated by reference herein in its entirety.

### BACKGROUND

### 1. Technical Field

The present disclosure relates to a data deletion control device and a non-transitory computer-readable storage medium storing a program.

### 2. Related Art

JP-A-2022-43511 discloses a storage device having a management unit that stores acquired data in a first area of a storage unit when the acquired data is a first type of data which is not deleted in response to a deletion instruction by an unauthenticated user but is deleted in response to a deletion instruction by an authenticated user, that does not store the acquired data in a second area of the storage unit even when the acquired data does not fit in the first area, that stores the acquired data in the first area when the acquired data is a second type of data which is deleted in response to a deletion instruction by a user, that stores at least a part of the acquired data in the second area when the acquired data does not fit in the first area, that stores the acquired data in the second area when the acquired data is a third type of data which is automatically deleted regardless of a deletion instruction by a user, and that stores at least part of the acquired data in the first area when the acquired data does not fit in the second area.

JP-A-2022-43511 is an example of the related art.

However, in the storage device described in JP-A-2022-43511, the determination about whether to delete data may not be appropriate.

### SUMMARY

According to an aspect of the present disclosure, a data deletion control device includes: an acquisition unit configured to acquire data from each of a plurality of source devices including a first source device and a second source device; a storage unit configured to store the data acquired by the acquisition unit; and a deletion unit configured to execute deletion processing of deleting the data from the storage unit in response to a preset deletion condition being satisfied when the data is acquired from the first source device, the deletion unit prohibiting execution of the deletion processing of the data when the data is acquired from the second source device.

According to another aspect of the present disclosure, a non-transitory computer-readable storage medium storing a program is provided, the program being executed by a processor provided in a data deletion control device, the program causing the processor to function as: an acquisition unit configured to acquire data from each of a plurality of source devices including a first source device and a second source device; a storage unit configured to store the data acquired by the acquisition unit; and a deletion unit configured to execute deletion processing of deleting the data from the storage unit in response to a preset deletion condition being satisfied when the data is acquired from the first source device, the deletion unit prohibiting execution of the deletion processing of the data when the data is acquired from the second source device.

### BRIEF DESCRIPTION OF THE DRAWINGS

FIG. 1 shows an example of the configuration of a communication system according to an embodiment.

FIG. 2 shows an example of the configuration of a tablet device according to the embodiment.

FIG. 3 is a screen view showing an example of a favorites setting screen displayed when newly generating fifth data.

FIG. 4 is a flowchart showing an example of processing by a control unit of the tablet device.

### DESCRIPTION OF EMBODIMENTS

An embodiment will now be described with reference to the drawings.

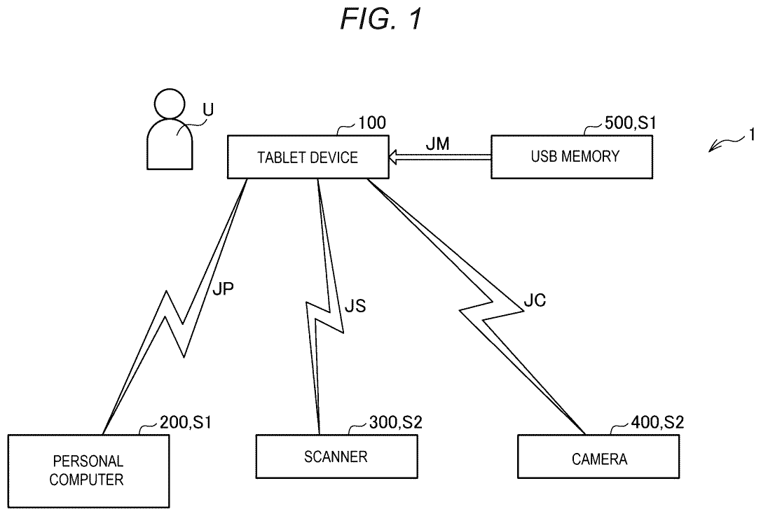

First, the configuration of a communication system 1 according to this embodiment will be described with reference to FIG. 1. FIG. 1 shows an example of the configuration of the communication system 1 according to this embodiment. As shown in FIG. 1, the communication system 1 has a tablet device 100, a personal computer 200, a scanner 300, a camera 400, and a Universal Serial Bus (USB) memory 500.

The tablet device 100 is connected in such a way as to be able to perform wireless communication with each of the personal computer 200, the scanner 300, and the camera 400, for example, in conformity with the Wi-Fi (trademark registered) standard. The tablet device 100 also accepts an operation from a user U.

While a case where the tablet device 100 is connected in such a way as to be able to perform wireless communication with each of the personal computer 200, the scanner 300, and the camera 400 is described in this embodiment, the present disclosure is not limited to this. The tablet device 100 may be connected in any communicable manner with each of the personal computer 200, the scanner 300, and the camera 400. The tablet device 100 may be connected in such a way as to be able to perform wired communication with each of the personal computer 200, the scanner 300, and the camera 400, for example, via an Ethernet (trademark registered) cable and in conformity with the Ethernet (trademark registered) standard.

The tablet device 100 receives first data JP such as document information or image information from the personal computer 200. The document information is generated by the personal computer 200, for example, based on an operation from the user.

The tablet device 100 receives second data JS such as image information from the scanner 300. The image information is generated by the scanner 300 reading an image formed on an original document, for example, based on an operation from the user.

The tablet device 100 receives third data JC such as image information from the camera 400. The image information is generated by the camera 400 picking up an image, for example, based on an operation from the user.

The USB memory 500 is attached to the tablet device 100. The USB memory 500 stores fourth data JM such as document information or image information. The tablet device 100 acquires the fourth data JM such as document information or image information from the USB memory 500.

The tablet device 100 has a function of displaying a character or an image on an operation display mechanism 120, described later. With this function, the tablet device 100 operates as a viewer that displays data acquired from the personal computer 200, the scanner 300, the camera 400, and the USB memory 500. For example, when the tablet device 100 acquires the first data JP, the tablet device 100 displays a document or an image based on the acquired first data JP. For example, when the tablet device 100 acquires the second data JS, the tablet device 100 displays an image based on the second data JS. For example, when the tablet device 100 acquires the third data JC, the tablet device 100 displays an image based on the third data JC. For example, when the tablet device 100 acquires the fourth data JM, the tablet device 100 displays a document or an image based on the fourth data JM.

Each of the personal computer 200 and the USB memory 500 is equivalent to an example of a first source device S1.

Each of the scanner 300 and the camera 400 is equivalent to an example of a second source device S2.

The first source device S1 and the second source device S2 are included in a source device S.

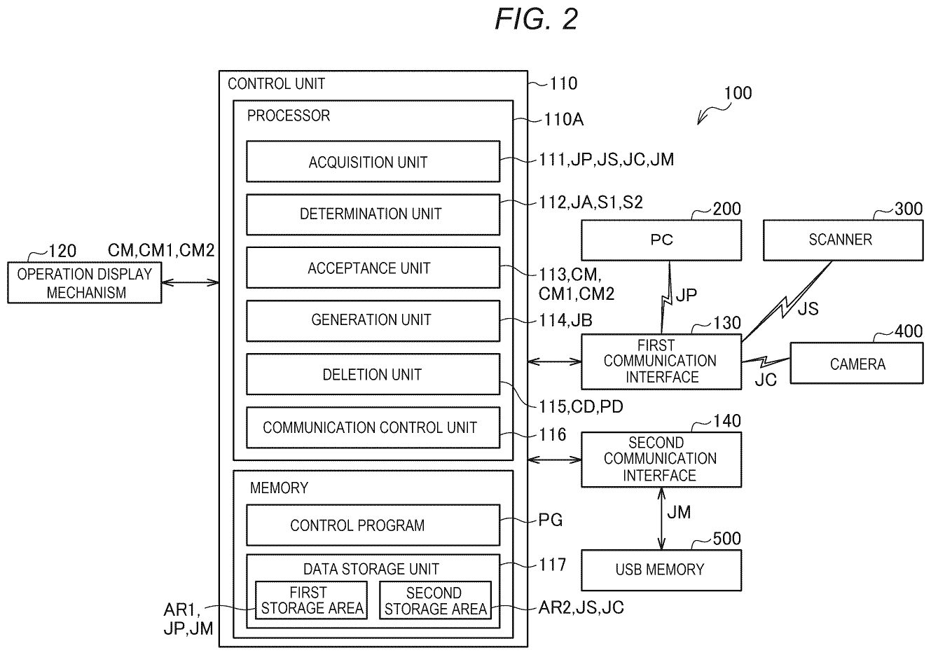

The first source device S1 and the second source device S2 will be described further with reference to FIG. 2.

In this embodiment, the source device S means a device functioning as a data source that supplies data to the tablet device 100.

The tablet device 100 is equivalent to an example of a “data deletion control device”.

The camera 400 is equivalent to an example of an “image pickup device”. The USB memory 500 is equivalent to an example of a “storage device”.

The configuration of the tablet device 100 will now be described with reference to FIG. 2. FIG. 2 shows an example of the configuration of the tablet device 100 according to this embodiment.

As shown in FIG. 2, the tablet device 100 has a control unit 110, an operation display mechanism 120, a first communication interface 130, and a second communication interface 140. The control unit 110 controls each part of the tablet device 100. Each of the operation display mechanism 120, the first communication interface 130, and the second communication interface 140 is communicably coupled to the control unit 110.

The control unit 110 has a processor 110A such as a central processing unit (CPU), and a memory 110B such as a read-only memory (ROM). The memory 110B stores a control program PG.

The processor 110A may be formed of a plurality of processors or may be formed of a single processor.

The processor 110A may be hardware programmed to implement the functions of each unit, described later. That is, the processor 110A may have a configuration in which the control program PG is installed as a hardware circuit. In this case, for example, the processor 110A is formed of an application-specific integrated circuit (ASIC), a field-programmable gate array (FPGA) or the like. In the description below, a case where the processor 110A executes the control program PG and thus implements various functions of the control unit 110 is described.

The memory 110B has a storage area where a program executed by the processor 110A and data processed by the processor 110A are stored. The memory 110B stores the control program PG executed by the processor 110A, and various image data, setting data, and the like related to operations of the tablet device 100.

The memory 110B has a nonvolatile storage area where a program and data are stored in a nonvolatile manner. The memory 110B may have, for example, a ROM, a random-access memory (RAM), a hard disk drive (HDD), a solid-state drive (SSD) or the like, as the nonvolatile storage area. The memory 110B has a volatile storage area, which may form a work area where a program executed by the processor 110A and data to be processed are temporarily stored. The memory 110B may have, for example, a RAM, as the volatile storage area.

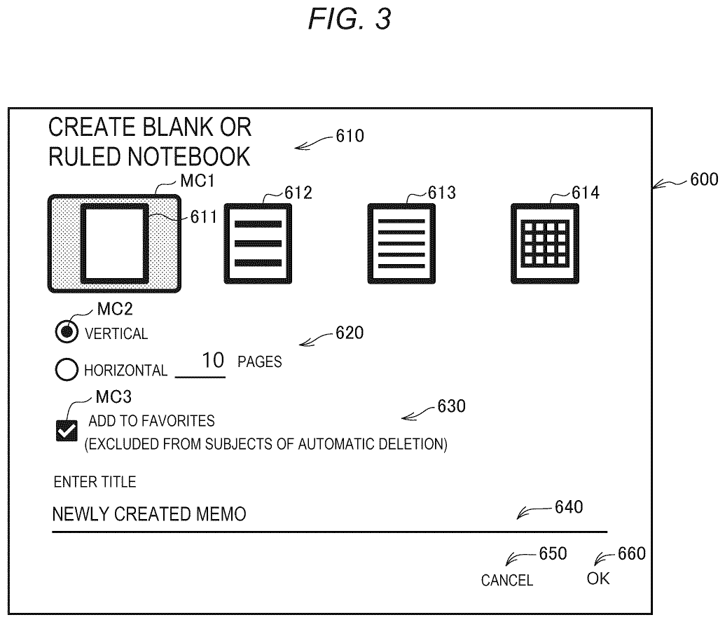

The operation display mechanism 120 has, for example, a display panel such as a liquid crystal panel (LCD), and a touch sensor integrated with a display surface of the display panel. The operation display mechanism 120 executes the display of information, or the like, on the LCD under the control of the control unit 110. The LCD displays, for example, a favorites setting screen 600 shown in FIG. 3.

The touch sensor accepts an operation from the user U. The touch sensor generates a signal corresponding to the operation accepted from the user U and outputs the generated signal to the control unit 110. The touch sensor detects, for example, an operation to the favorites setting screen 600 shown in FIG. 3, generates a signal corresponding to the operation, and outputs the generated signal to the control unit 110.

The first communication interface 130 is a communication interface that executes wireless communication with each of the personal computer 200, the scanner 300, and the camera 400 in conformity with the Wi-Fi (trademark registered) standard. The first communication interface 130 has an antenna that sends and receives a Wi-Fi (trademark registered) signal, and an interface circuit that processes a signal transmitted via the antenna. The first communication interface 130 is an interface board having the antenna and the interface circuit, and is coupled to a main board where the processor 110A or the like of the control unit 110 is mounted. Alternatively, the antenna and the interface circuit that form the first communication interface 130 are mounted on the main board of the control unit 110. The first communication interface 130 receives the first data JP from the personal computer 200, receives the second data JS from the scanner 300, and receives the third data JC from the camera 400.

The second communication interface 140 is a communication interface that executes wired communication in conformity with the USB standard. The second communication interface 140 has a connector that sends and receives a USB signal, and an interface circuit that processes a signal transmitted via the connector. The connector and the interface circuit of the second communication interface 140 are mounted on the main board of the control unit 110. The USB memory 500 is attached to the connector of the second communication interface 140, and the second communication interface 140 acquires the fourth data JM from the USB memory 500.

As shown in FIG. 2, the control unit 110 has an acquisition unit 111, a determination unit 112, an acceptance unit 113, a generation unit 114, a deletion unit 115, a communication control unit 116, and a data storage unit 117. These units are implemented, for example, by the processor 110A executing the control program PG and thus the collaboration between software and hardware. In other words, the processor 110A executes the control program PG and thus functions as the acquisition unit 111, the determination unit 112, the acceptance unit 113, the generation unit 114, the deletion unit 115, and the communication control unit 116. Also, the processor 110A executes the control program PG and thus causes the memory 110B to function as the data storage unit 117.

The control program PG is equivalent to an example of a “program”.

The data storage unit 117 stores data acquired by the acquisition unit 111. The data storage unit 117 includes a first storage area AR1 and a second storage area AR2. In the first storage area AR1, data acquired from the first source device S1 by the acquisition unit 111 is stored. The first source device S1 includes the personal computer 200 and the USB memory 500. That is, for example, the first data JP and the fourth data JM are stored in the first storage area AR1. The first data JP is data acquired from the personal computer 200 by the acquisition unit 111. The fourth data JM is data acquired from the USB memory 500 by the acquisition unit 111.

In the second storage area AR2, data acquired from the second source device S2 by the acquisition unit 111 is stored. The second source device S2 includes the scanner 300 and the camera 400. That is, for example, the second data JS and the third data JC are stored in the second storage area AR2. The second data JS is data acquired from the scanner 300 by the acquisition unit 111. The third data JC is data acquired from the camera 400 by the acquisition unit 111.

The data storage unit 117 is equivalent to an example of a “storage unit”.

The acquisition unit 111 acquires data from each of a plurality of source devices including the first source device S1 and the second source device S2. The first source device S1 includes, for example, the personal computer 200 and the USB memory 500. The second source device S2 includes, for example, the scanner 300 and the camera 400.

That is, for example, the acquisition unit 111 acquires the first data JP from the personal computer 200 and acquires the fourth data JM from the USB memory 500. Also, for example, the acquisition unit 111 acquires the second data JS from the scanner 300 and acquires the third data JC from the camera 400. The acquisition unit 111 stores the first data JP, the fourth data JM, the second data JS, and the third data JC in the data storage unit 117. For example, the acquisition unit 111 stores the first data JP and the fourth data JM in the first storage area AR1 of the data storage unit 117. Also, for example, the acquisition unit 111 stores the second data JS and the third data JC in the second storage area AR2 of the data storage unit 117.

When the acquisition unit 111 acquires data JA, the determination unit 112 determines whether the acquisition unit 111 acquires the data JA from the first source device S1. Also, when the acquisition unit 111 acquires the data JA, the determination unit 112 determines whether the acquisition unit 111 acquires the data JA from the second source device S2. The data JA is one of the first data JP, the fourth data JM, the second data JS, and the third data JC.

When the determination unit 112 determines that the data JA is acquired from the first source device S1, the deletion unit 115 executes deletion processing PD of deleting the data JA from the data storage unit 117 in response to a preset deletion condition CD being satisfied.

When the determination unit 112 determines that the data JA is acquired from the second source device S2, the deletion unit 115 prohibits the execution of the deletion processing PD of the data JA.

The deletion condition CD is, for example, that the number of data stored in the first storage area AR1 of the data storage unit 117 exceeds a preset threshold number THM. The threshold number THM is, for example, 30.

For example, when the number of data stored in the first storage area AR1 of the data storage unit 117 is 31, the deletion unit 115 deletes one data with the oldest date and time of being stored in the first storage area AR1 of the data storage unit 117, as the deletion processing PD.

Also, for example, when the number of data stored in the first storage area AR1 of the data storage unit 117 is 32, the deletion unit 115 deletes two data in order from the oldest date and time of being stored in the first storage area AR1 of the data storage unit 117, as the deletion processing PD.

When the determination unit 112 determines that the data JA is acquired from the second source device S2, the acceptance unit 113 accepts an instruction CM from the user about whether to execute the deletion processing PD in response to the deletion condition CD being satisfied.

When the acceptance unit 113 accepts a first instruction CM1 indicating that the deletion processing PD is to be executed in response to the deletion condition CD being satisfied, the acceptance unit 113 stores the data JA in the first storage area AR1 of the data storage unit 117. Consequently, the data JA is changed to data on which the deletion processing PD is to be executed in response to the deletion condition CD being satisfied.

Meanwhile, when the acceptance unit 113 accepts a second instruction CM2 indicating that the deletion processing PD is not to be executed in response to the deletion condition CD being satisfied, the acceptance unit 113 stores the data JA in the second storage area AR2 of the data storage unit 117.

When the determination unit 112 determines that the data JA is acquired from the first source device S1, the acceptance unit 113 does not accept the instruction from the user about whether to execute the deletion processing PD.

The generation unit 114 newly generates fifth data JB, based on an instruction from the user U. The generation unit 114 stores the generated fifth data JB, for example, in the second storage area AR2 of the data storage unit 117. That is, the deletion unit 115 prohibits the execution of the deletion processing PD of the fifth data JB. When the generation unit 114 generates the fifth data JB, the acceptance unit 113 accepts the instruction CM from the user about whether to execute the deletion processing PD in response to the deletion condition CD being satisfied.

When the acceptance unit 113 accepts the first instruction CM1 indicating that the deletion processing PD is to be executed in response to the deletion condition CD being satisfied, the acceptance unit 113 stores the fifth data JB in the first storage area AR1 of the data storage unit 117. Consequently, the fifth data JB is changed to data on which the deletion processing PD is to be executed in response to the deletion condition CD being satisfied.

The communication control unit 116 receives the first data JP from the personal computer 200, receives the second data JS from the scanner 300, and receives the third data JC from the camera 400, via the first communication interface 130.

The communication control unit 116 also acquires fourth data JM from the USB memory 500 via the second communication interface 140.

FIG. 3 is a screen view showing an example of the favorites setting screen 600 displayed on the LCD of the operation display mechanism 120 by the acceptance unit 113 when the generation unit 114 newly generates the fifth data JB.

Referring to FIG. 3, a case of generating data corresponding to a blank notebook or a ruled notebook, as the fifth data JB newly generated by the generation unit 114, will be described.

As shown in FIG. 3, the favorites setting screen 600 includes a title display section 610, a first format 611, a second format 612, a third format 613, a fourth format 614, a vertical-or-horizontal and number-of-sheets setting section 620, a favorites setting section 630, a file name input section 640, a cancel button 650, and an OK button 660.

In the title display section 610, “create blank or ruled notebook” is displayed, indicating that it is the favorites setting screen 600 displayed when the user newly generates data corresponding to a blank or ruled notebook as the fifth data JB.

The first format 611, the second format 612, the third format 613, and the fourth format 614 are displayed below the title display section 610.

As the first format 611, the second format 612, the third format 613, and the fourth format 614, formats of data corresponding to the notebook newly created by the user U are displayed in a selectable manner. For example, the first format 611 corresponds to a blank notebook and the second format 612 corresponds to a notebook of wide ruled sheets. The third format 613 corresponds to a notebook of narrower ruled sheets than the second format 612. The fourth format 614 corresponds to a notebook of grid ruled sheets.

In FIG. 3, the first format 611 is selected by the user U. A selection mark MC1 indicates that the first format 611 is selected by the user U.

The vertical-or-horizontal and number-of-sheets setting section 620 accepts, from the user U, the selection about whether sheets used for the notebook are vertically long or horizontally long. The vertical-or-horizontal and number-of-sheets setting section 620 also accepts the number of sheets used for the notebook, from the user U.

In FIG. 3, a check mark MC2 is displayed at a position corresponding to vertically long, and vertically long is selected. The number of sheets is set to be 10 pages.

The favorites setting section 630 sets whether to store the data of the notebook generated as the fifth data JB, in the first storage area AR1 or the second storage area AR2 of the data storage unit 117, based on an input from the user U.

In the favorites setting section 630, text information “add to favorites (excluded from subjects of automatic deletion)” and a check mark input part are displayed.

In the favorites setting section 630, a check mark MC3 is displayed in the check mark input part as a default setting. In this case, the data of the notebook generated as the fifth data JB is stored in the second storage area AR2 of the data storage unit 117. In this case, the deletion unit 115 prohibits the execution of the deletion processing PD of the fifth data JB.

When the check mark MC3 in the check mark input part is erased based on an operation by the user, the data of the notebook generated as the fifth data JB is stored in the first storage area AR1 of the data storage unit 117. In this case, the deletion unit 115 executes the deletion processing PD of the fifth data JB in response to the deletion condition CD being satisfied.

The file name input section 640 accepts, from the user U, the input of a file name corresponding to the notebook generated as the fifth data JB.

The cancel button 650 is touched by the user U when cancelling all of the settings and the inputs made by the user U on the favorites setting screen 600.

The OK button 660 is touched by the user U when executing all of the settings and the inputs made by the user U on the favorites setting screen 600.

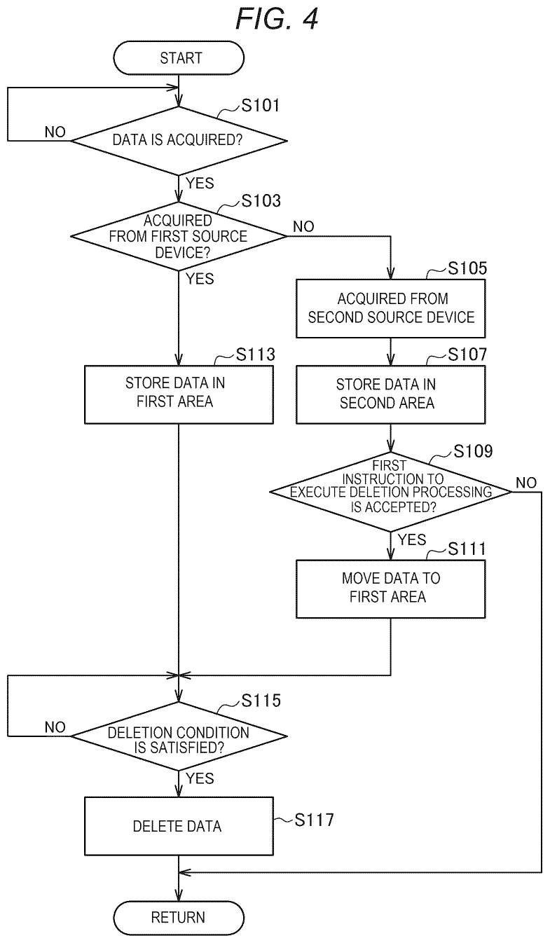

Processing by the control unit 110 of the tablet device 100 will now be described with reference to FIG. 4. FIG. 4 is a flowchart showing an example of the processing by the control unit 110 of the tablet device 100.

First, in step S101, whether the acquisition unit 111 acquires the data JA is determined.

When it is determined that the acquisition unit 111 does not acquire the data JA (NO in step S101), the processing turns into a standby state. When it is determined that the acquisition unit 111 acquires the data JA (YES in step S101), the processing proceeds to step S103.

In step S103, the determination unit 112 determines whether the acquisition unit 111 acquires the data JA from the first source device S1.

When the determination unit 112 determines that the acquisition unit 111 acquires the data JA from the first source device S1 (YES in step S103), the processing proceeds to step S113. When the determination unit 112 determines that the acquisition unit 111 does not acquire the data JA from the first source device S1 (NO in step S103), the processing proceeds to step S105.

In step S105, the determination unit 112 determines that the acquisition unit 111 acquires the data JA from the second source device S2.

Next, in step S107, the acquisition unit 111 stores the data JA in the second storage area AR2 of the data storage unit 117. Since the data JA is stored in the second storage area AR2, the execution of the deletion processing PD of the data JA is prohibited.

Next, in step S109, the acceptance unit 113 determines whether the first instruction CM1 indicating that the deletion processing PD is to be executed in response to the deletion condition CD being satisfied is accepted.

When the acceptance unit 113 determines that the first instruction CM1 is not accepted (NO in step S109), the processing is subsequently returned to step S101. When the acceptance unit 113 determines that the first instruction CM1 is accepted (YES in step S109), the processing proceeds to step S111.

In step S111, the acceptance unit 113 stores the data JA in the first storage area AR1 of the data storage unit 117. In other words, the acceptance unit 113 moves the data JA from the second storage area AR2 to the first storage area AR1 of the data storage unit 117. Since the data JA is moved from the second storage area AR2 to the first storage area AR1, the prohibition of the execution of the deletion processing PD of the data JA is cancelled. The processing then proceeds to step S115.

Next, in step S115, the deletion unit 115 determines whether the deletion condition CD is satisfied. The deletion condition CD is, for example, that the number of data stored in the first storage area AR1 of the data storage unit 117 exceeds a preset threshold number THM. The threshold number THM is, for example, 30.

When the deletion unit 115 determines that the deletion condition CD is not satisfied (NO in step S115), the processing turns into the standby state. When the deletion unit 115 determines that the deletion condition CD is satisfied (YES in step S115), the processing proceeds to step S117.

In step S117, the deletion unit 115 executes the deletion processing PD. That is, the deletion unit 115 deletes data stored in the first storage area AR1 of the data storage unit 117 in order from the oldest data. Subsequently, the processing is returned to step S101. The number of data to be deleted by the deletion unit 115 corresponds to the difference resulting from subtracting the threshold number THM from the number of data stored in the first storage area AR1 of the data storage unit 117 before the deletion.

The function of the tablet device 100 as a viewer is executed, for example, separately from or in parallel with the operation shown in FIG. 4. For example, the acquisition unit 111 displays information about the acquired data JA on the operation display mechanism 120 after the data JA is stored in the first storage area AR1 in step S113 and after the data JA is stored in the second storage area AR2 in step S107. This operation is executed separately from the operation shown in FIG. 4. The acquisition unit 111 causes the operation display mechanism 120 to display a document or an image based on the data JA in response to an operation to the operation display mechanism 120.

When the deletion processing PD is executed in step S117, the deletion unit 115 may perform the processing of excluding the data JA that is not displayed by the viewer function of the tablet device 100, from the data to be deleted. For example, when the data to be deleted is data with no history of being displayed by the viewer function in the processing of deleting the data stored in the first storage area AR1 in order from the oldest data, the deletion unit 115 may skip the processing of deleting the data. When the data to be deleted is data with no history of being displayed by the viewer function, the deletion unit 115 may display a screen to request the selection about whether to delete the data on the operation display mechanism 120. When an operation of selecting the deletion is accepted, the deletion unit 115 executes the deletion, whereas when an operation of not selecting the deletion is accepted, the deletion unit 115 may skip the deletion of the data.

As described above with reference to FIGS. 1 to 4, the tablet device 100 according to this embodiment has the acquisition unit 111 configured to acquire the data JA from each of a plurality of source devices S including the first source device S1 and the second source device S2, the data storage unit 117 configured to store the data JA acquired by the acquisition unit 111, and the deletion unit 115 configured to execute the deletion processing PD of deleting the data JA from the data storage unit 117 in response to the preset deletion condition CD being satisfied when the data JA is acquired from the first source device S1, and the deletion unit 115 prohibits the execution of the deletion processing PD of the data JA when the data JA is acquired from the second source device S2.

In this configuration, when the data JA is acquired from the first source device S1, the deletion processing PD of deleting the data JA from the data storage unit 117 is executed in response to the preset deletion condition CD being satisfied, and when the data JA is acquired from the second source device S2, the execution of the deletion processing PD of deleting the data JA is prohibited.

Therefore, when each of the first source device S1 and the second source device S2 is set appropriately, the deletion processing PD can be executed appropriately. Thus, a shortage of residual capacity in the data storage unit 117 due to a large amount of data to be deleted that are stored in the data storage unit 117 can be suppressed. Also, a loss of convenience for the user due to the deletion of data that should not be deleted from the data storage unit 117 can be suppressed.

The tablet device 100 according to this embodiment also has the acceptance unit 113 configured to accept an instruction from the user U about whether to execute the deletion processing PD in response to the deletion condition CD being satisfied when the data JA is acquired from the second source device S2, and the acceptance unit 113 does not accept the instruction from the user U about whether to execute the deletion processing PD when the data JA is acquired from the first source device S1.

In this configuration, when the data JA is acquired from the second source device S2, the instruction from the user U about whether to execute the deletion processing PD in response to the deletion condition CD being satisfied is accepted, and when the data JA is acquired from the first source device S1, the instruction from the user U about whether to execute the deletion processing PD is not accepted.

Therefore, even with the data JA acquired from the second source device S2, when the user determines that the deletion processing PD may be executed in response to the deletion condition CD being satisfied, the deletion processing PD is executed in response to the deletion condition CD being satisfied. Thus, a shortage of residual capacity in the data storage unit 117 due to a large amount of data to be deleted that are stored in the data storage unit 117 can be suppressed.

In the tablet device 100 according to this embodiment, the first source device S1 includes the personal computer 200 communicably coupled to the tablet device 100.

In this configuration, the first source device S1 includes the personal computer 200. Therefore, when the first data JP is acquired from the personal computer 200, the deletion processing PD of deleting the first data JP from the data storage unit 117 is executed in response to the preset deletion condition CD being satisfied. Since the first data JP is stored in the personal computer 200, the first data JP can be easily acquired from the personal computer 200 even when the first data JP is deleted from the tablet device 100. Thus, a shortage of residual capacity in the data storage unit 117 due to a large amount of data to be deleted that are stored in the data storage unit 117 can be suppressed.

In the tablet device 100 according this embodiment, the first source device S1 includes the USB memory 500 communicably coupled to the tablet device 100 and configured to store the data JA.

In this configuration, the first source device S1 includes the USB memory 500. Therefore, when the fourth data JM is acquired from the USB memory 500, the deletion processing PD of deleting the fourth data JM from the data storage unit 117 is executed in response to the preset deletion condition CD being satisfied. Since the fourth data JM is stored in the USB memory 500, the fourth data JM can be easily acquired from the USB memory 500 even when the fourth data JM is deleted from the tablet device 100. Thus, a shortage of residual capacity in the data storage unit 117 due to a large amount of data to be deleted that are stored in the data storage unit 117 can be suppressed.

In the tablet device 100 according to this embodiment, the second source device S2 includes the camera 400 and the scanner 300.

In this configuration, the second source device S2 includes the camera 400 and the scanner 300. Therefore, when the tablet device 100 acquires the third data JC from the camera 400, the tablet device 100 prohibits the execution of the deletion processing PD of the third data

JC. When the third data JC is deleted from the tablet device 100 and the third data JC is not stored in the camera 400, the user U cannot easily acquire the third data JC again. Also, when the second data JS is acquired from the scanner 300, the execution of the deletion processing PD of the second data JS is prohibited. When the second data JS is deleted from the tablet device 100 and the second data JS is not stored in the scanner 300, the user U cannot easily acquire the second data JS again. Thus, a loss of convenience for the user U due to the deletion of data that should not be deleted from the data storage unit 117 can be suppressed.

The tablet device 100 according to this embodiment also has the generation unit 114 configured to newly generate the fifth data JB, and the deletion unit 115 prohibits the execution of the deletion processing PD of the fifth data JB generated by the generation unit 114.

In this configuration, the tablet device 100 prohibits the execution of the deletion processing PD of the newly generated fifth data JB. Since the fifth data JB is data newly generated in the tablet device 100, the user U cannot acquire the fifth data JB when the fifth data JB is deleted. Thus, a loss of convenience for the user U due to the deletion of data that should not be deleted from the data storage unit 117 can be suppressed.

The control program PG of the tablet device 100 according to this embodiment is the control program PG executed by the processor 110A provided in the tablet device 100, and causes the processor 110A to function as the acquisition unit 111 configured to acquire the data JA from each of a plurality of source devices S including the first source device S1 and the second source device S2, the data storage unit 117 configured to store the data JA acquired by the acquisition unit 111, and the deletion unit 115 configured to execute the deletion processing PD of deleting the data JA from the data storage unit 117 in response to the preset deletion condition CD being satisfied when the data JA is acquired from the first source device S1, and the deletion unit 115 prohibits the execution of the deletion processing PD of the data JA when the data JA is acquired from the second source device S2.

This configuration achieves effects similar to those of the tablet device 100 according to this embodiment.

This embodiment represents one aspect and any modifications and applications can be made thereto without departing from the spirit and scope of the present disclosure.

While the case where the “data deletion control device” is formed of the tablet device 100 is described in this embodiment, the present disclosure is not limited to this. The “data deletion control device” may have the control unit 110, the first communication interface 130, and the second communication interface 140 described with reference to FIG. 2. The “data deletion control device” may be formed of, for example, a smartphone. The “data deletion control device” may also be formed of, for example, a so-called laptop computer or a personal computer. In such cases, a function of displaying and outputting data, a function of editing data, and a function of deleting the data are provided. The “data deletion control device” may also be formed of, for example, a printer, a copier, or a multifunction peripheral (MFP). In such cases, a function of printing and outputting data and a function of deleting the data are provided.

While the case where the “image pickup device” is the camera 400 is described in this embodiment, the present disclosure is not limited to this. The “image pickup device” may pick up and form an image of a subject. The “image pickup device” may be, for example, a video camera.

While the case where the “storage device” is the USB memory 500 is described in this embodiment, the present disclosure is not limited to this. The “storage device” may store data and output the stored data to the tablet device 100. The “storage device” may be, for example, a card-type memory configured to be attachable to and removable from the tablet device 100. The “storage device” may be, for example, an SD (trademark registered) card or a micro SD (trademark registered) card.

The source device coupled to the tablet device 100 is not limited to the above examples, and which source is defined as the first source device and which source is defined as the second source device are not necessarily limited. For example, when the tablet device 100 has a configuration with a built-in camera, a camera outside the tablet device 100 may be defined as the first source device, and the built-in camera in the tablet device 100 may be defined as the second source device.

The deletion condition for automatic deletion by the deletion processing PD can be set in any manner. For example, a deletion condition about data volume or date size or about a not-in-use period, which is a period when data is not used, may be set, and data matching these deletion conditions may be deleted by the deletion processing PD.

The deletion condition is not limited to one deletion condition and a plurality of conditions for automatic deletion may be set, such as a second deletion condition in addition to a deletion condition. In this case, at least one deletion condition may preferably be a condition such that automatic deletion is performed for data acquired from the first source device, whereas automatic deletion is not performed for data acquired from the second source device, as described in the embodiment.

While the case where the processor 110A provided in the tablet device 100 executes the control program PG and thus implements various functions is described in the embodiment, the present disclosure may be configured in the form of a recording medium in which the control program PG is recorded in a computer-readable manner or a transmission medium that transmits the control program PG.

As the recording medium, a magnetic or optical recording medium or a semiconductor memory device can be used. The recording medium may be a portable or fixed recording medium, such as a flexible disc, an HDD, a compact disk read-only memory (CD-ROM), a digital versatile disk (DVD), a Blu-ray (trademark registered) disc, a magneto-optical disc, a flash memory, or a card-type recording medium.

The recording medium may be a nonvolatile storage device such as a RAM, a ROM, or an HDD that is an internal storage device provided in the tablet device 100.

The functions of the control unit 110 of the tablet device 100 may be implemented by one or a plurality of processors or a semiconductor chip. The control unit 110 may further have a co-processor such as a system-on-a-chip (SoC), a micro-control unit (MCU), or an FPGA. The control unit 110 may perform various kinds of control by causing the CPU and the co-processor to collaborate with each other or selectively using one of the CPU and the co-processor.

The processing steps in the flowchart of FIG. 4 are provided by dividing the processing according to the main content of the processing in order to facilitate the understanding of the processing by the control unit 110 of the tablet device 100, and the way the processing is divided into processing steps and the names of the processing steps do not limit the present disclosure. The processing steps in the flowchart may be divided into more processing steps according to the content of the processing. The processing may also be divided in such a way that one processing step includes more processing. The order of the processing may be suitably replaced without departing from the spirit and scope of the present disclosure.

Each functional unit shown in FIG. 2 represents a functional configuration and is not particularly limited to any specific form of installation. A piece of hardware individually corresponding to each of the functional units needs not necessarily be installed, and a single processor may be configured to execute a program and thus implement functions of a plurality of functional units. A part of the functions implemented by software in the foregoing embodiment may be implemented by hardware, or a part of the functions implemented by hardware may be implemented by software. Also, the specific detailed configurations of the other parts of the tablet device 100 can be changed according to need without departing from the spirit and scope of the present disclosure.

What is claimed is:

1. A data deletion control device comprising:
an acquisition unit configured to acquire data from each of a plurality of source devices including a first source device and a second source device;
a storage unit configured to store the data acquired by the acquisition unit; and
a deletion unit configured to execute deletion processing of deleting the data from the storage unit in response to a preset deletion condition being satisfied when the data is acquired from the first source device,
the deletion unit prohibiting execution of the deletion processing of the data when the data is acquired from the second source device.

2. The data deletion control device according to claim 1, further comprising:
an acceptance unit configured to accept an instruction from a user about whether to execute the deletion processing in response to the deletion condition being satisfied when the data is acquired from the second source device, wherein
the acceptance unit does not accept the instruction from the user about whether to execute the deletion processing when the data is acquired from the first source device.

3. The data deletion control device according to claim 1, wherein
the first source device includes a personal computer communicably coupled to the data deletion control device.

4. The data deletion control device according claim 1, wherein
the first source device includes a storage device communicably coupled to the data deletion control device and configured to store the data.

5. The data deletion control device according to claim 1, wherein
the second source device includes at least one of an image pickup device and a scanner.

6. The data deletion control device according to claim 1, further comprising:
a generation unit configured to newly generate data, wherein
the deletion unit prohibits the execution of the deletion processing of the data generated by the generation unit.

7. A non-transitory computer-readable storage medium storing a program, the program being executed by a processor provided in a data deletion control device,
the program causing the processor to function as:
an acquisition unit configured to acquire data from each of a plurality of source devices including a first source device and a second source device;
a storage unit configured to store the data acquired by the acquisition unit; and
a deletion unit configured to execute deletion processing of deleting the data from the storage unit in response to a preset deletion condition being satisfied when the data is acquired from the first source device,
the deletion unit prohibiting execution of the deletion processing of the data when the data is acquired from the second source device.
